(19) United States
(12) Patent Application Publication
(10) Pub. No.: US 2017/0284896 A1
(43) Pub. Date: Oct. 5, 2017

(54) SYSTEM AND METHOD FOR UNSUPERVISED ANOMALY DETECTION ON INDUSTRIAL TIME-SERIES DATA

(71) Applicant: General Electric Company, Schenectady, NY (US)

(72) Inventors: Abhay HARPALE, San Ramon, CA (US); Achalesh Kumar PANDEY, San Ramon, CA (US); Alexander NARKAJ, San Ramon, CA (US); Alexander Turner GRAF, San Ramon, CA (US); Hao HUANG, San Ramon, CA (US)

(21) Appl. No.: 15/474,563

(22) Filed: Mar. 30, 2017

Related U.S. Application Data
(60) Provisional application No. 62/315,989, filed on Mar. 31, 2016.

(51) Int. Cl. G01M 15/02; G01M 15/14

(52) U.S. Cl. CPC G01M 15/02; G01M 15/14

(57) ABSTRACT

The present embodiments related to a machinery failure evaluation system and associated method. The system may receive time-series data associated with a piece of machinery. An anomaly associated with the piece of machinery may automatically be determined by comparing the time-series data with a model associated with the piece of machinery. Furthermore, it may be determined that the anomaly is not a known fault based on performing a lookup of known failure modes. In a case that the anomaly is not a known fault, an alert associated with an unknown failure mode may be transmitted.

### CROSS-REFERENCE TO RELATED APPLICATION

This application claims benefit of U.S. provisional patent application No. 62/315,989, filed Mar. 31, 2016 entitled “SYSTEM AND METHOD FOR UNSUPERVISED ANOMALY DETECTION ON INDUSTRIAL TIME-SERIES DATA”, which application is incorporated herein by reference.

### BACKGROUND

Machinery, such as aircraft engines and turbines are subject to failure for numerous reasons. For example, an aircraft engine may fail due to a problem with an engine component such as a combustor or a fan. Known machinery failures are typically detected by sensors and, once a failure is detected, the failure is only then reported to an operator for correction.

Conventional strategies employed for the detection of failures are typically developed based on known problems that have previously occurred in the machinery. These prior occurrences may be determined by automatically inferring sensor profiles that correspond to known abnormal behavior associated with the particular problem. However, for problems that have never had prior occurrences, failures often come without any warning or prior indication. In this situation, the cost of repair may be significantly greater than if the failure had been detected early. Furthermore, late detection of a failure may jeopardize the safety of the machinery. It would therefore be desirable to provide systems and methods to detect unknown abnormal behavior in machinery in an automatic and accurate manner.

### BRIEF DESCRIPTION OF THE DRAWINGS

FIG. 1 illustrates a system in accordance with some embodiments.

FIG. 2A illustrates dashboard flow according to some embodiments.

FIG. 2B illustrates dashboard flow according to some embodiments.

FIG. 3 illustrates a process according to some embodiments.

FIG. 4 illustrates an evaluation system according to some embodiments.

FIG. 5A illustrates anomaly detection results according to some embodiments.

FIG. 5B illustrates anomaly detection results according to some embodiments.

FIG. 5C illustrates anomaly detection results according to some embodiments.

FIG. 6A illustrates anomaly detection results according to some embodiments.

FIG. 6B illustrates anomaly detection results according to some embodiments.

FIG. 6C illustrates anomaly detection results according to some embodiments.

FIG. 7 is an example manifold learning in accordance with some embodiments.

FIG. 8A illustrates anomaly detection results according to some embodiments.

FIG. 8B illustrates anomaly detection results according to some embodiments.

FIG. 8C illustrates anomaly detection results according to some embodiments.

### DETAILED DESCRIPTION

In the following detailed description, numerous specific details are set forth in order to provide a thorough understanding of the embodiments. However, it will be understood by those of ordinary skill in the art that the embodiments may be practiced without these specific details. In other instances, well-known methods, procedures, components and circuits have not been described in detail so as not to obscure the embodiments.

The present embodiments relate to a novel framework for unsupervised anomaly detection associated with industrial multivariate time-series data. Unsupervised detection may be essential in “unknown-unknown” scenarios, where operators are unaware of potential failures and haven't observed any prior occurrences of such unknown failures. The framework described herein may comprise a comprehensive suite of algorithms, data quality assessment, missing value imputation, feature generation, validation and evaluation modules. The framework may determine unknown failures based on comparing a normal engine profile model (e.g., all sensors indicting values in a normal range) with reported differences in a current state of the engine. Sensors may be associated with various measurable elements of a piece of machinery such as, but not limited to, vibration, temperature, pressure, and environmental changes, etc. In some embodiments, determining unknown failures (e.g., evaluation) relates to discovering a failure that is about to happen (e.g., early detection). In some embodiments, determining unknown failures relates to early detection as well a case where a failure has happened in the past.

As used herein, the term “model” may refer to, for example, a structured model that includes information about various items, and relationships between those items, and may be used to represent and understand a piece of machinery. By way of example, the model might relate to a learned model of specific types of: jet engines, gas turbines, wind turbines, etc. Note that any of the models described herein may include relationships between sensors within the piece of machinery or phases of the machinery. By way of examples only, a phase of a piece of machinery may relate a function of the piece of machinery at a particular time. For example, a jet engine may be associated with a takeoff phase, an in-flight phase and a landing phase, etc.

Therefore, by comparing how a normal engine profile model deviates from normal operation for a particular phase, an operator may be presented with anomalies that serve as indicators which may point to a cause of the anomalies as well as the sensors/drivers that are behind the anomalies.

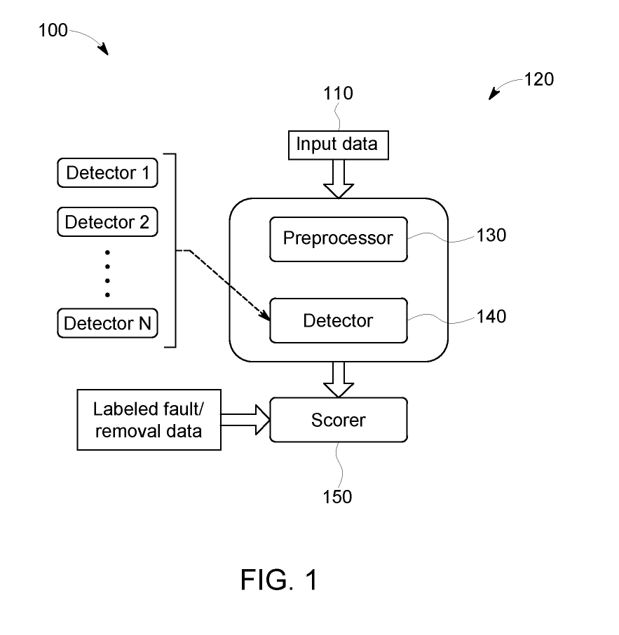

FIG. 1 is a high-level architecture of a system 100 for anomaly detection according to some embodiments. The system 100 may receive input data 110 associated a piece of machinery. The input data 110 may be received at an evaluation platform 120 that comprises a preprocessor 130, a detector 140 and a scorer 150. The preprocessor 130, the detector 140 and the scorer 150 may each be implemented as hardware or as software modules of the evaluation platform 120. In some embodiments, the detector 140 may comprise a plurality of detectors. In some embodiments, the scorer 150 may output an anomaly score. In some embodiments, and as illustrated in FIG. 1, the scorer 150 may receive labeled fault data.

As used herein, devices, including those associated with the system 100 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The evaluation platform 120 may receive input data 110 from a plurality of sensors, from a database, or from another system such as an onboard data collection system. The database (not shown in FIG. 1), may be used by the evaluation platform 120 to store information into and/or retrieve information associated with a piece of machinery being evaluated on a periodic basis (e.g., daily, weekly, monthly). The database may be locally stored or reside remote from the evaluation platform 120. Although a single evaluation platform 120 is shown in FIG. 1, any number of such devices may be included. Moreover, various devices described herein might be combined according to embodiments of the present invention. For example, in some embodiments, the evaluation platform 120 and database might comprise a single apparatus. In some embodiments, the input data 110 may be received in real-time from the plurality of sensors or another system.

The preprocessor 130 may receive the input data 110 and cleanse the input data 110 to remove spurious data associated the plurality of sensors. For example, the preprocessor 130 may remove noise or data associated with problematic sensors or remove data associated with a time frame when an engine was in a repair shop which may have created data unrelated to in-use potential faults.

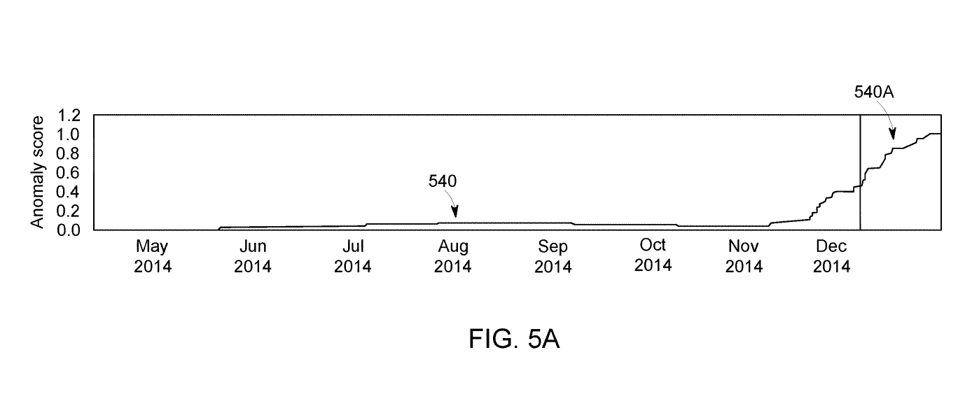

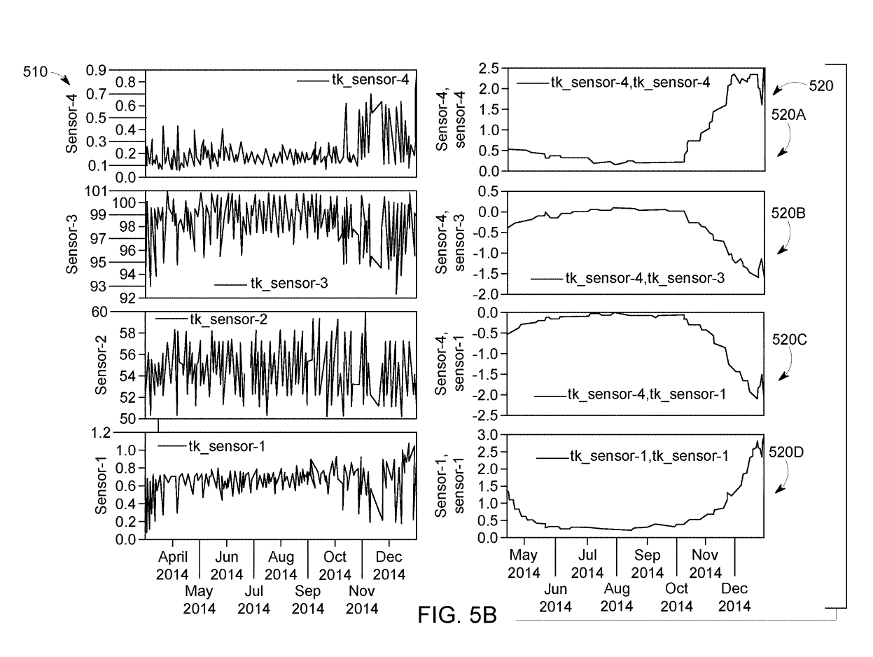

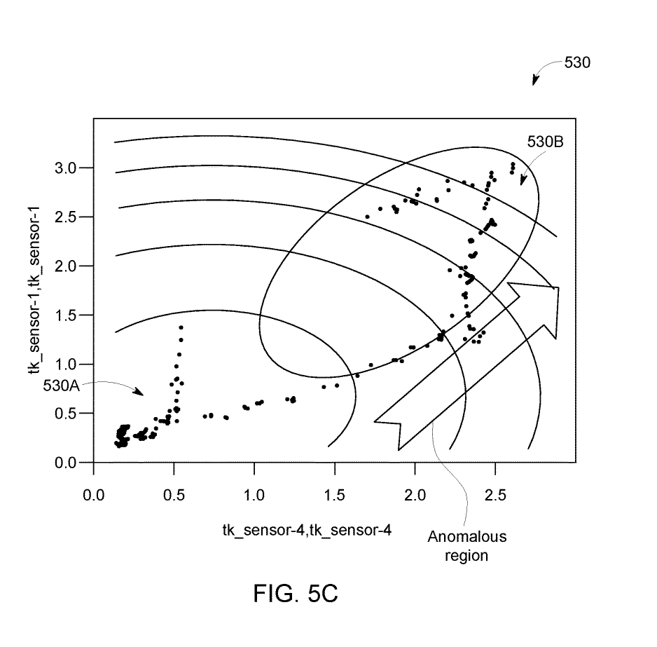

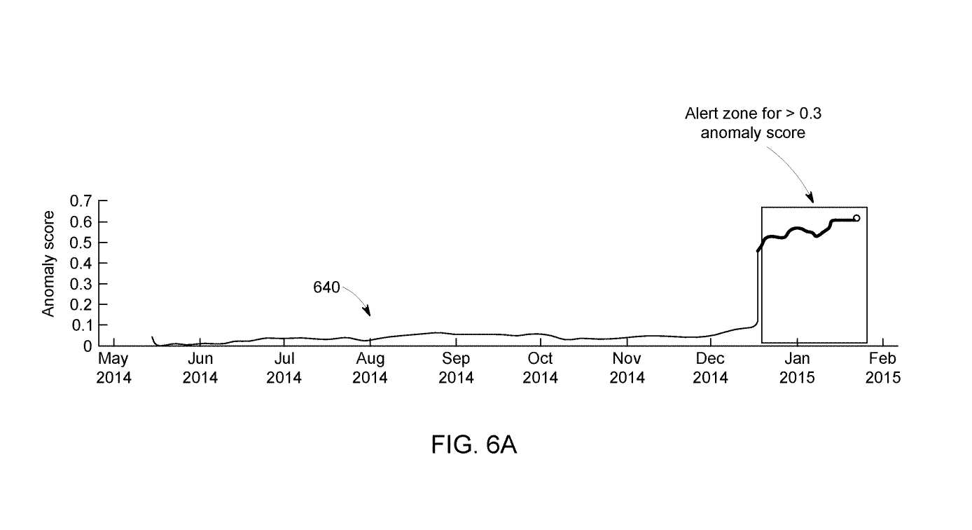

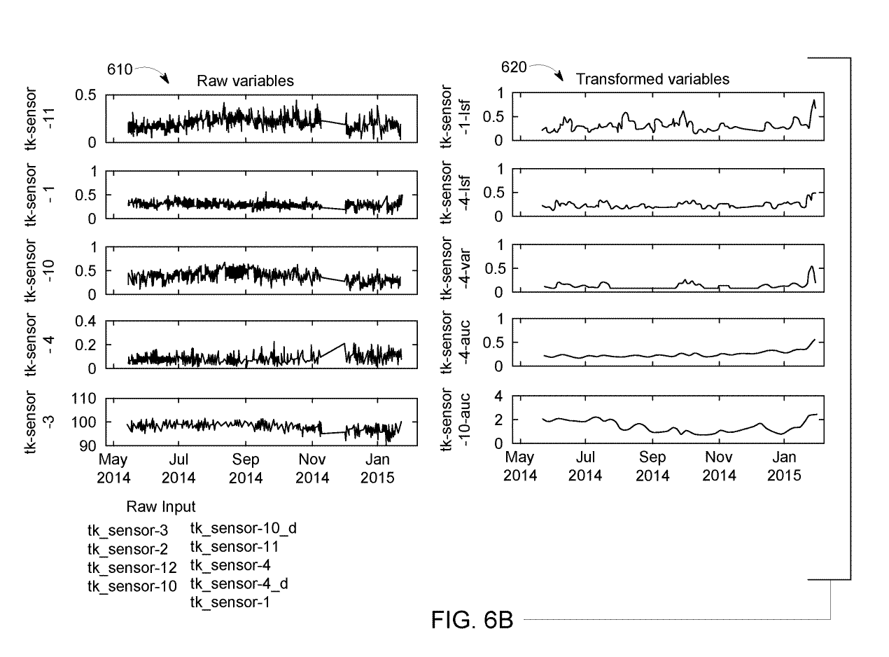

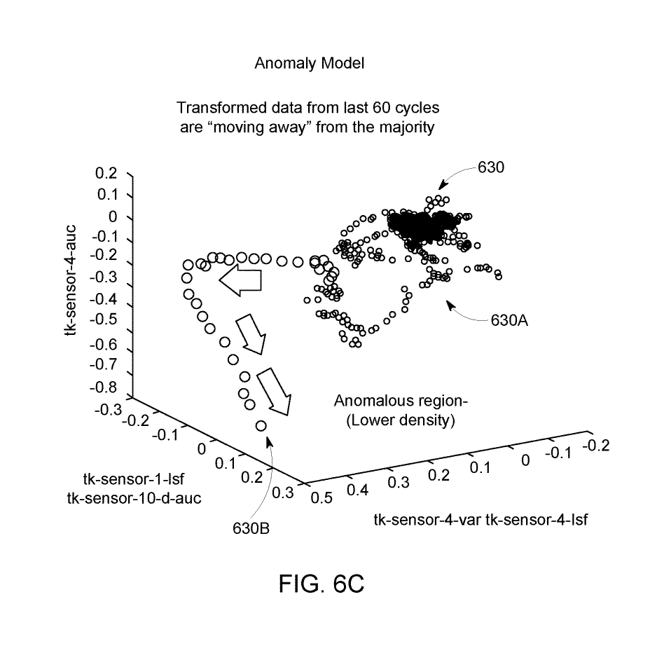

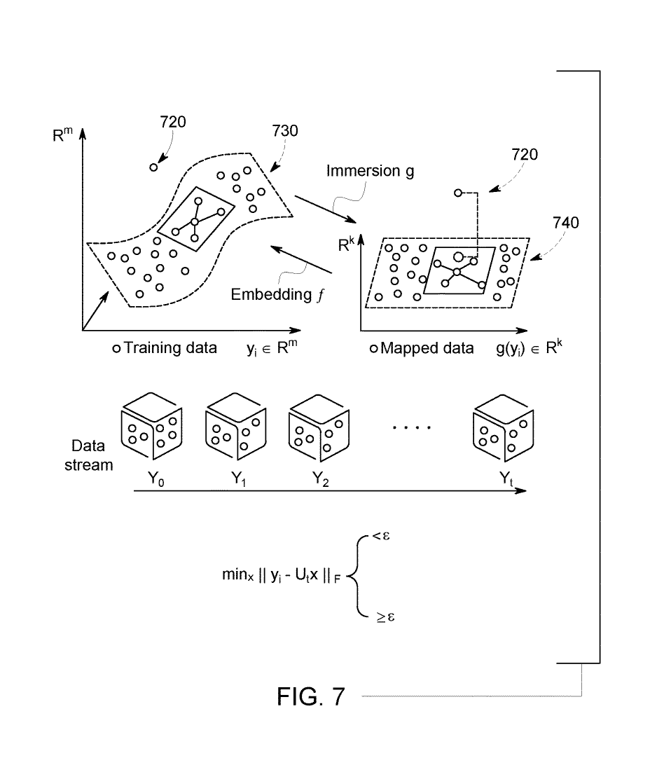

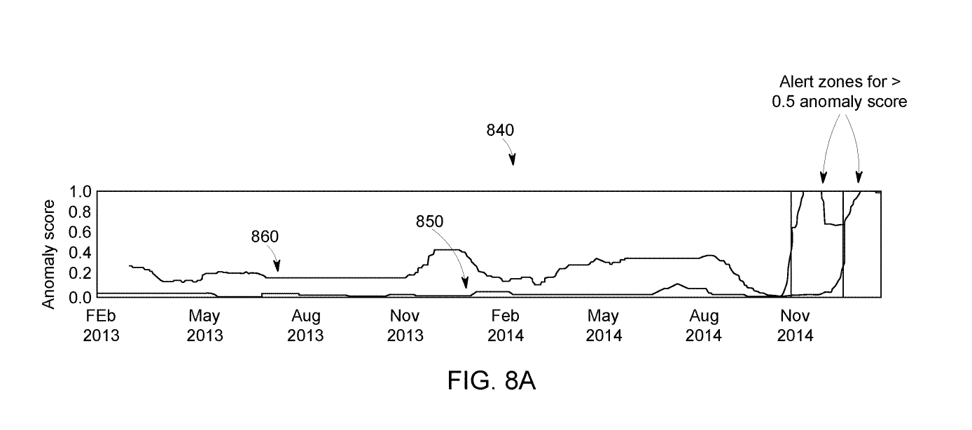

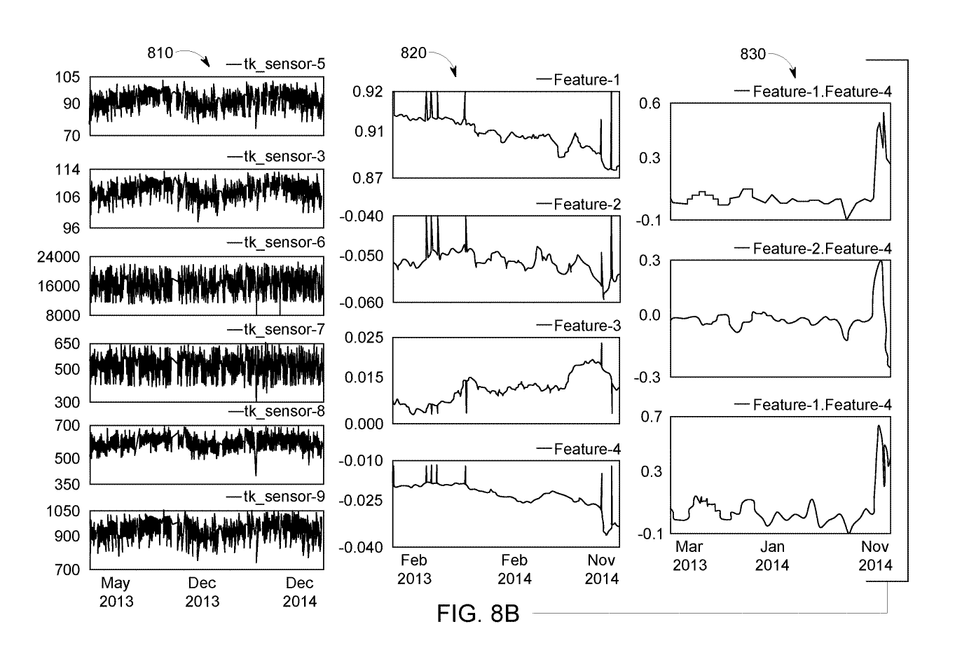

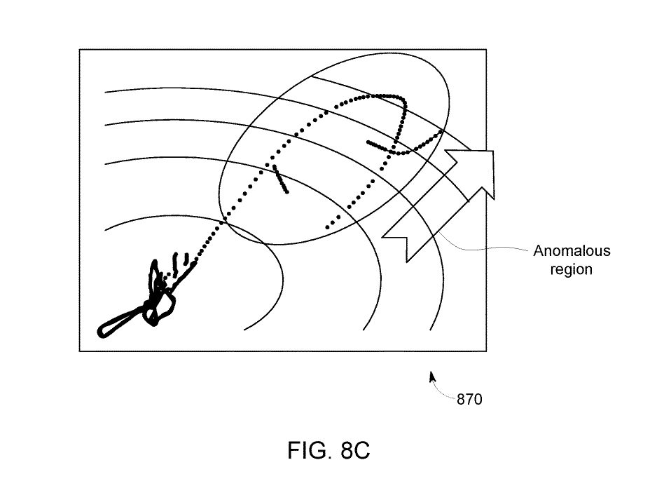

The detector 140 may use one or more of a plurality of algorithms to determine anomalies associated with the input data 110. For example, examples of different algorithms will be discussed with respect to FIG. 5A-FIG. 5C, FIG. 6A-FIG. 6C, FIG. 7 and FIG. 8A-FIG. 8C. Once anomalies are detected, the detected anomalies may be scored to determine if a level or amount of anomalies reaches a threshold that triggers an alert to an operator. By alerting an operator to anomalies prior to an actual failure, repair costs of the machinery may be reduced and the safety of the machinery may be increased. For example, in a case that a bearing, or an unknown fault, in an aircraft engine is showing signs of degradation, the bearing may be replaced prior to actual engine damage or a risk to passengers. Similarly, the unknown fault may be addressed prior to actual engine damage and passenger risk.

In some embodiments, the system 100 may be broken down into a plurality of modules. For example, the system 100 may comprise the following modules:

Preprocessing: This module may offer automatic data imputation, relevant feature selection, and component level compartmentalization of sensor observations. For example, preprocessing may cleanse input data to remove spurious data associated the plurality of sensors such as noise, data associated with problematic sensors or data unrelated to in-use potential faults.

Feature generation: This module may offer several strategies for automatically generating feature representations that are relevant, interpretable and optimal for the problem setting.

Detector suite: This module may provide a generalized interface to a library of diverse anomaly detection algorithms. Each of the algorithms in the library may provide mechanisms for training the model by inferring the usual behavior (e.g., inferring sensors results that indicate values in a normal range) of the asset family being monitored, and then predict anomaly scores for future observations. Algorithms may have been chosen and developed to enable the capture of a diversity of anomalies.

Alertization: This module may provide anomaly scores generated by the Detector suite that can be converted into alerts in an intelligent manner, with the goal of reducing spurious alarms and false alarms.

Evaluation: The evaluation module may provide a comprehensive scoring of methods being tested. It may include metrics of recall, precision, coverage and false positive rate, but may also provide lead-time-to-detection, performance under specific lead-time criteria (e.g., 30-days in advance). It may also provide comparison of the framework to data associated with a repair shop visit as well as existing models for anomaly detection and alert generation.

Feature importance: The feature importance module may be supported by each of the anomaly detector algorithms, wherein, the algorithm may provide an importance score for each of the underlying features (or sensors) at each time-instant by automatically identifying the contribution of a feature to the anomaly score at that time instant. For example, sensors or groups of sensors may be ranked based on their contribution to feature information (e.g., a number of sensors associated with each feature). This may enable a validation of the algorithmic scores, and may also enable root-cause analysis by guiding an analyst to a correct component for inspection.

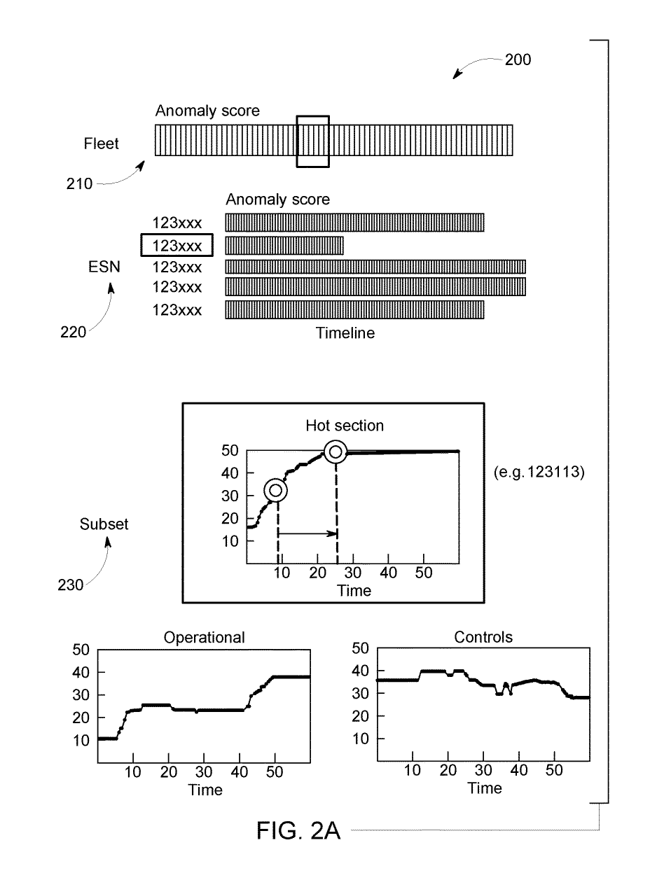

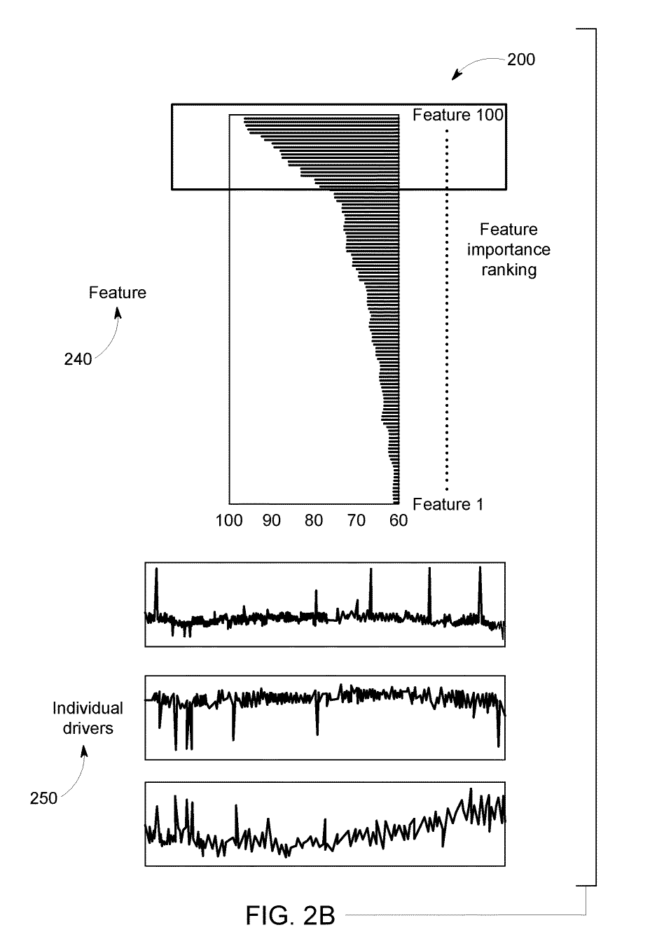

In a case that the system 100 detects anomalies in time-series data to a degree that an operator is alerted, the evaluation platform 120 may provide a dashboard for the operator to further analyze the anomalies. For example, FIG. 2 and FIG. 2B illustrates a dashboard 200 that might be used in conjunction with the system 100 described with respect to FIG. 1.

Referring now to FIG. 2A and FIG. 2B, an embodiment of a dashboard 200 is illustrated. The dashboard 200 may facilitate an operator in determining a cause of detected anomalies. The dashboard 200 may comprise a plurality of views. For example, a high-level view 210 may be associated with a highest level of all machinery. In some embodiments, the high-level view 210 may be associated with a fleet of machines such as, but not limited to, a fleet of aircraft. The operator may view the high-level view 210 to visualize a portion of the fleet that is experiencing anomalies. While in this particular example, the grouping may be associated with an entire fleet of aircraft, the grouping may also be based on a customer type or a customer location.

At a next lower level, the high-level view 210 may be broken down into a second level view such as a serial number level view 220 (e.g., an ESN view). The serial number level view 220 may break down the high-level group of machinery into serial number groupings. In the present example, the serial number view 220 may break down the high-level group 210 into five different groups with each of the five groups starting with serial number 123. In the present example, serial number grouping 123113 illustrates a high number of anomalies. In some embodiments, once a serial number group from the serial number view 220 is determined to have anomalous indicators, the particular serial number group from the serial number level view 220 may be broken down into functional subsets at a subset view 230. For example, the functional subsets may be associated with a hot section, an operational system, or a control system of machinery associated with a particular serial number (e.g., 123113).

Each subset from the subset view 230 may be broken down into a plurality of features which may be displayed in the feature view 240. In the present example, the hot section may be selected. In some embodiments, since each subset from the subset view 230 may be associated with a plurality of features, the features associated with each subset may be ranked and displayed in an order of importance. The ranking may be based on, for example, a predetermined ranking retrieved from a database or may be based on a number of sensors associated with each feature (e.g., a greater number of sensors equates to a higher ranking). Each feature of a subset may be associated with one or more sensors and each sensor may be associated with a desired operating value. However, in a case that the desired value is indicated as being out of range, then one or more of the underlying sensors, associated with the feature, may be contributing to the feature having a high number of anomalies (e.g., a high anomaly score). In this case, it may be desirable to determine which sensor is indicating a high number of anomalies.

The individual driver view 250 may break down individual features from the feature view 240 into the particular sensors associated with each feature. In this way, the data from a particular sensor, associated with one or more anomalies, may be examined. Examining individual sensors associated with anomalies may facilitate determining a future failure of an unknown type. This may indicate to an engineer or repair personnel a particular component that is failing or is indicating as potentially failing.

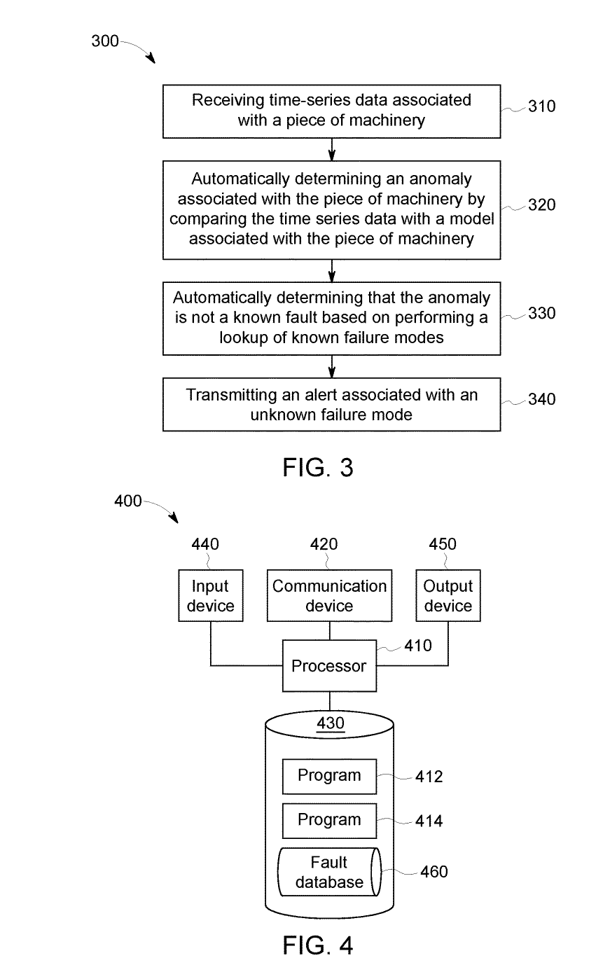

Now referring to FIG. 3, an embodiment of a process 300 may be illustrated according to some embodiments. The process 300 described herein does not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, time-series data associated with a piece of machinery may be received. The time-series data may be received at an evaluation system. The piece of machinery might be associated with, for example, a physical engine, a rotor, a turbine or other electrical and/or mechanical device.

The embodiments described herein may be implemented using any number of different hardware configurations. For example, FIG. 4 is block diagram of an evaluation platform 400 that may be, for example, associated with the system 100 of FIG. 1. The evaluation platform 400 may comprise a processor 410, such as one or more commercially available Central Processing Units (CPUs) in the form of one-chip microprocessors, coupled to a communication device 420 configured to communicate via a communication network (not shown in FIG. 4). The communication device 420 may be used to communicate, for example, with one or more remote devices (e.g., to receive input data associated with a piece of machinery). The evaluation platform 400 may further include an input device 440 (e.g., a computer mouse and/or keyboard to input information about repair history data or related model information) and an output device 450 (e.g., a computer monitor to display models and/or generate reports).

The processor 410 also communicates with a storage device 430. The storage device 430 may comprise any appropriate information storage device, including combinations of magnetic storage devices (e.g., a hard disk drive), optical storage devices, and/or semiconductor memory devices. The storage device 430 may store programs 412 and 414 for controlling the processor 410. The processor 410 performs instructions of the programs 412, 414, and thereby operates in accordance with any of the embodiments described herein. For example, the processor 410 may receive sensor data associated with a piece of machinery. In some embodiments, a preprocessor may cleanse the received sensor data. The preprocessor may be associated with a processor, a co-processor or one or more processor cores.

The processor 410 may automatically determine an anomaly associated with the piece of machinery by comparing received time-series data with a normal engine profile model associated with the piece of machinery. The normal engine profile model may be based on the piece of machinery with all related sensor values in a predicted range (i.e., a healthy state of the machinery). Furthermore, the processor 410 may automatically determine that the anomaly is not a known fault based on performing a lookup of known failure modes. Known failure modes may be determined based on fault characteristic data that is stored in a database. The fault characteristic data may comprise data such as, but not limited to, temperatures, currents, resistances, etc. that is associated with and may be used to identify known faults. For example, a specific failure mode may be associated with a component that has a specific temperature range over a period of time and exhibits a high resistance.

The programs 412, 414 may be stored in a compressed, uncompiled and/or encrypted format. The programs 412, 414 may furthermore include other program elements, such as an operating system, clipboard application a database management system, and/or device drivers used by the processor 410 to interface with peripheral devices.

As used herein, information may be “received” by or “transmitted” to, for example: (i) the evaluation platform 400 from another device; or (ii) a software application or module within the evaluation platform 400 from another software application, module, or any other source.

In some embodiments (such as shown in FIG. 4), the storage device 430 stores fault database 460. The fault database 460 may store a plurality of known faults and fault characteristic data associated with each known fault. The fault characteristic data may comprise data such as, but not limited to, temperatures, currents, resistances, etc. that may be used to identify known faults. Note that the database described herein is only one example, and additional and/or different information may be stored therein. Moreover, various databases might be split or combined in accordance with any of the embodiments described herein.

Referring back to FIG. 3, at S20 an anomaly associated with the piece of machinery is automatically determined by comparing the received time-series data with a normal engine profile model associated with the piece of machinery. For example, and now referring to FIG. 5A, FIG. 5B and FIG. 5C, a first embodiment of determining an anomaly is illustrated.

FIG. 5B illustrates time-series data 510 associated with four different sensors. The sensors associated with time-series data 510 are indicated as SENSOR-1, SENSOR-2, SENSOR-3 and SENSOR-4. Transformed data is illustrated at 520. The transformed data 520 may comprise a transformation that is used to illustrate an estimated relationship between two different sensors. For example, using a covariance transform, the estimated relationship between SENSOR-4 and SENSOR-4 may be illustrated at 520A, the estimated relationship between SENSOR-4 and SENSOR-3 may be illustrated at 520B, the estimated relationship between SENSOR-1 and SENSOR-4 may be illustrated at 520C and the estimated relationship between SENSOR-1 and SENSOR-1 may be illustrated at 520C. In some embodiments, the estimated relationships may be associated with two or more sensors. However, in some embodiments, the estimated relationships may also relate to estimated relationships of individual features of the time-series data for two or more sensors.

The covariance relationship may be calculated by first calculating a covariance σ(x,y) for each pair of features x and y. N may be set to 50 for covariance of 50 cycles. Therefore, a covariance relationship formula may be as follows:

$$σ ( x , y ) = \frac{1}{N - 1} {\sum }_{i = 1}^{N} ( {x}_{i} - \overline{x} ) ( {y}_{i} - \overline{y} )$$

As illustrated at 530 in FIG. 5C, once the time-series data has been transformed to illustrate estimated relationships, the estimated relationships may be plotted. As shown at 530A, data points that are associated with a majority grouping are non-anomalous data points. However, as the data points move further and further away from the majority grouping 530A, the data points move to an anomalous region 530B. This anomalous region may also be illustrated in graph 540 in FIG. 5A.

As illustrated in the example associated with graph 540, an anomaly score over a period of 7 months may be very low (e.g., less than 0.1) but over approximately a one month period, the anomaly score rapidly increases (e.g., to 1.0) which may trigger an alert that the piece of machinery being monitored may be subject to a failure. Furthermore, as illustrated at 540A, when the anomaly scores increase to a predefined level (e.g., 0.5) an alert is activated.

Turning now to FIG. 6A, FIG. 6B and FIG. 6C, a second embodiment of determining an anomaly is illustrated. The second embodiment of determining an anomaly may be based on manifold learning. Manifold learning may comprise an approach to non-linear dimensionality reduction based on determining if data points fall on a sheet of data points. For example, the sheet of data points (e.g., a manifold) may comprise a three-dimensional sheet of data points. In some embodiments, the sheet of data points may comprise a lower than N-dimensional sheet of points, where N is the dimensionality of the original input. For example, the sheet may comprise a three-dimensional sheet of data points. Non-anomalous data points may fall on the three-dimensional sheet while anomalous data points may not fall on the three-dimensional sheet. For example, and now referring to FIG. 7, a plurality of data points 710 are fit onto sheet 730. However, data point 720 resides apart from the sheet 730. Data point 720 may comprise an anomalous data point. This is further illustrated at 740 where data points 710 reside on a single sheet 740 while data point 720 is apart from the sheet 740.

Referring back to FIG. 6A, FIG. 6B and FIG. 6C, similar to FIG. 5A, FIG. 5B and FIG. 5C, raw time-series data 610 may be transformed into transformed data 620 to illustrate estimated relationships between two sensors. The transformed data 620 may be plotted based on manifold learning where anomalous data points may be illustrated as “moving away” from the manifold containing the majority of the data points. As illustrated in graph 630, the majority of data points are located at 630A while the anomalous data point 630B has moved away from the majority of data points located at 630A.

Furthermore, and as illustrated in graph 640, an anomaly score over a period of eight months may be very low (e.g., less than 0.1) but over a next month, the anomaly score rapidly increases (e.g., to 0.6). In this case, after entering an alert zone associated with a predetermined amount of anomalies (e.g., in this case the alert zone starts at 0.3) an alert that the piece of machinery may be subject to a failure may be triggered.

Turning now to FIG. 8A, FIG. 8B and FIG. 8C, a third embodiment of determining an anomaly may be illustrated. The third embodiment of determining an anomaly may be based on an application of physics derived features, such as efficiency and flow calculations from raw sensor data, which are applied to the time-series data prior to a transformation of the time-series data. By applying physics derived features before transforming the data into estimated relationships of two or more sensors, efficiencies associated with the physical features of the systems being sensed may provide earlier detection of anomalies.

For example, time-series data 810 may be associated with a plurality of sensors. The time-series data 820 may be modified by the application of physics derived features which are associated with physical efficiencies of the piece of machinery. The results of the application of physics derived features may be illustrated at 820. Once the physics derived features are applied, the time-series data having the physics derived features 820 applied may then be transformed into transform results 830.

Graph 840, illustrates a comparison of an anomaly score 850 using a first technique, such as that described with respect to FIG. 5A-5C and FIG. 6A-6C compared to a second technique 860, such as calculating an anomaly score using the application of physics derived features. As can be visualized in graph 840 and graph 870, anomalies are detected quicker using the application of physics derived features since the anomaly score rises to an alert level faster than the methods discussed with respect to FIG. 5A-5C and FIG. 6A-6C. In the illustrated example, when using the application of physics derived features the alert zone is reached over a month prior to the methods discussed with respect to FIG. 5A-5C and FIG. 6A-6C. Thus, when using the application of physics derived features, machinery, such as engines, rotors, and turbines may be diagnosed quicker than the methods discussed with respect to FIG. 5A-5C and FIG. 6A-6C thus providing more time for unknown faults of unknown reasons to be determined.

Referring back to FIG. 3, the anomaly is automatically determined to be associated with an unknown fault at S330. For example, the data associated with an anomaly may be automatically looked up in a database of known fault states (e.g. the fault database 460). If the data corresponds to a known fault then an operator may be alerted to that known fault. However, if the fault is not a known fault then an unknown fault may be indicated and an alert associated with an unknown failure mode may be transmitted at S340 to an operator, an alert system, or other device.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A machinery failure evaluation system comprising:
a processor;
a non-transitory computer-readable medium comprising instructions that, when executed by the processor, perform a method, the method comprising:
receiving time-series data associated with a piece of machinery;
automatically determining an anomaly associated with the piece of machinery by comparing the received time-series data with a model associated with the piece of machinery;
automatically determining that the anomaly is not a known fault based on performing a lookup of known failure modes; and
transmitting an alert associated with an unknown failure mode.

2. The system of claim 1, wherein the time-series data associated with a piece of machinery is received from a plurality of sensors and wherein determining an anomaly associated with the piece of machinery further comprises:
comparing a relationship between two features associated with two or more of the plurality of sensors.

3. The system of claim 1, wherein the time-series data associated with a piece of machinery is received from a plurality of sensors and wherein determining an anomaly associated with the piece of machinery further comprises:
comparing a relationship between two or more of the plurality of sensors.

4. The system of claim 3, wherein determining an anomaly associated with the piece of machinery further comprises:
applying a physics derived feature enhancement prior to comparing the relationship between the two or more sensors of the plurality of sensors.

5. The system of claim 3, wherein comparing a relationship between two or more of the plurality of sensors comprises the use of a covariance transform.

6. The system of claim 1, wherein the method further comprises:
providing a dashboard to a user in response to the transmission of an alert associated with an unknown failure mode, wherein the dashboard comprises:
a first level associated with a fleet of machines;
a second level, the second level to break down the first level into serial number groupings;
a third level, the third level to break down the second level into functional subsets; and
a fourth level, the fourth level to break down the third level into a plurality of features.

7. The system of claim 6, wherein the plurality of features are ranked and displayed in an order of importance.

8. The system of claim 7 wherein the ranking is based on a number of sensors associated with each feature of the plurality of features.

9. A method to evaluate machinery failures, the method comprising:
receiving time-series data associated with a piece of machinery;
automatically determining an anomaly associated with the piece of machinery by comparing the received time-series data with a model associated with the piece of machinery;
automatically determining that the anomaly is not a known fault based on performing a lookup of known failure modes; and
transmitting an alert associated with an unknown failure mode.

10. The method of claim 9, wherein the time-series data associated with a piece of machinery is received from a plurality of sensors and wherein determining an anomaly associated with the piece of machinery further comprises:
comparing a relationship between two features associated with two or more of the plurality of sensors.

11. The method of claim 9, wherein the time-series data associated with a piece of machinery is received from a plurality of sensors and wherein determining an anomaly associated with the piece of machinery further comprises:
comparing a relationship between two or more of the plurality of sensors.

12. The method of claim 11, wherein determining an anomaly associated with the piece of machinery further comprises:
applying a physics derived feature enhancement prior to comparing the relationship between the two or more sensors of the plurality of sensors.

13. The method of claim 11, wherein comparing a relationship between two or more of the plurality of sensors comprises the use of a covariance transform.

14. The method of claim 9, wherein the method further comprises:
providing a dashboard to a user in response to the transmission of an alert associated with an unknown failure mode, wherein the dashboard comprises:
a first level associated with a fleet of machines;
a second level, the second level to break down the first level into serial number groupings;
a third level, the third level to break down the second level into functional subsets; and
a fourth level, the fourth level to break down the third level into a plurality of features.

15. The method of claim 14, wherein the plurality of features are ranked and displayed in an order of importance.

16. The method of claim 15, wherein the ranking is based on a number of sensors associated with each feature of the plurality of features.

17. A non-transitory computer-readable medium comprising instructions that, when executed by the processor, perform a method, the method comprising:
receiving time-series data associated with a piece of machinery;
automatically determining an anomaly associated with the piece of machinery by comparing the received time-series data with a model associated with the piece of machinery;
automatically determining that the anomaly is not a known fault based on performing a lookup of known failure modes; and
transmitting an alert associated with an unknown failure mode.

18. The non-transitory computer-readable medium of claim 17, wherein the method further comprises:
providing a dashboard to a user in response to the transmission of an alert associated with an unknown failure mode, wherein the dashboard comprises:
a first level associated with a fleet of machines;
a second level, the second level to break down the first level into serial number groupings;
a third level, the third level to break down the second level into functional subsets; and
a fourth level, the fourth level to break down the third level into a plurality of features.

19. The non-transitory computer-readable medium of claim 18, wherein the plurality of features are ranked and displayed in an order of importance and the ranking is based on a number of sensors associated with each feature of the plurality of features.

20. The non-transitory computer-readable medium of claim 17, wherein the time-series data associated with a piece of machinery is received from a plurality of sensors and wherein determining an anomaly associated with the piece of machinery further comprises:
applying a physics derived feature enhancement to the data associated with two or more sensors of the plurality of sensors; and
comparing a relationship between the data associated with the two or more of the plurality of sensors via a covariance transform.
